(19) United States
(12) Patent Application Publication
(10) Pub. No.: US 2014/0149160 A1
(43) Pub. Date: May 29, 2014

(54) FACILITATING PERSONAL SHOPPING ASSISTANCE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/688,017

(22) Filed: Nov. 28, 2012

(51) Int. Cl. G06Q 30/06

(52) U.S. Cl. CPC G06Q 30/0617; G06Q 10/0631
USPC 705/7.13

(57) ABSTRACT

Systems and methods are disclosed herein for facilitating shopping assistance. A shopping list is posted by a principal and presented to a plurality of potential agents. Responses are received from the potential agents and a response manually or automatically selected. Partial access to a shopping account of the principal is provided to the selected agent. Partial access may enable the agent to view a shopping list generated by the agent and to associate transactions of the agent with the principal. At a point of sale (POS) an agent may be authenticated and enabled to select a principal with which to associate a transaction. Real time data may be transmitted to a principal as items of a shopping list are checked off by the agent and updates and feedback from the principal may be provided to the agent.

### BACKGROUND

1. Field of the Invention

This invention relates to systems and methods for facilitating delegation of shopping tasks.

2. Background of the Invention

People lead busy lives. Many times people are too busy with work to perform menial, trivial, or boring tasks such as cleaning and shopping. When not at work, most would prefer to be enjoying recreational activities or spending times with friends and family than perform such tasks. Most people are not in a position to hire full time staff. On the other hand, the time spent finding someone to do small tasks can eliminate any time savings. A number of online services exist to enable the quick assignment of small tasks to pre-screened individuals. In such services, the process of selecting a contractor can be as simple as posting a task description online, receiving responses from pre-screened respondents, selecting a respondent, and authorizing payment once as task has been performed.

The systems and methods described herein provide an improved approach for delegating shopping tasks both with and without use of a general purpose online task delegation service.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for methods in accordance with embodiments of the present invention;

FIG. 2 is a block diagram of a computing device suitable for implementing embodiments of the present invention;

FIG. 3 is a schematic block diagram of a server module in accordance with an embodiment of the present invention;

FIG. 4 is a schematic block diagram of a principal module in accordance with an embodiment of the present invention;

FIG. 5 is a schematic block diagram of an agent module in accordance with an embodiment of the present invention;

FIG. 6 is a schematic block diagram of a point of sale module in accordance with an embodiment of the present invention;

FIG. 7 is a process flow diagram of a method for delegating a shopping task in accordance with an embodiment of the present invention;

FIG. 8 is a process flow diagram of a method for executing a delegated shopping task in accordance with an embodiment of the present invention;

FIG. 9 is a process flow diagram of a method for settling a delegated shopping task in accordance with an embodiment of the present invention; and

FIG. 10 is a process flow diagram for executing a delegated shopping task at a point of sale in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

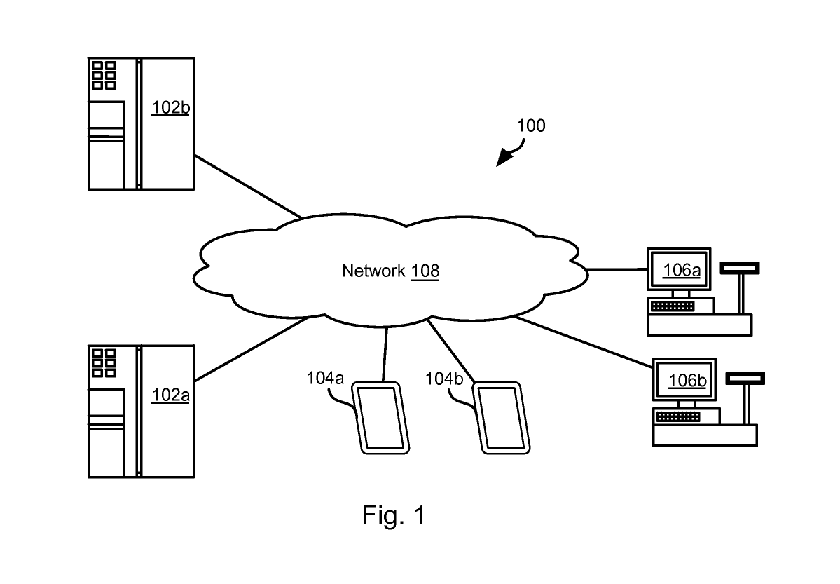

FIG. 1 illustrates a system 100 in which methods described hereinbelow may be implemented. The system 100 may include one or more server system 102a, 102b that may each be embodied as one or more server computers each including one or more processors that are in data communication with one another. The server systems 102a, 102b may be in data communication with one or more user computing devices 104a, 104b and one or more point of sale (POS) devices 106a, 106b. In the methods disclosed herein, the user computing devices 104a, 104b are advantageously mobile devices such as a mobile phone or tablet computer. As known in the art, many mobile phones and tablet computers also include cameras that can be used to scan optical codes such as barcodes, quick response (QR) codes, or textual information. In some embodiments, some or all of the methods disclosed herein may be performed using a desktop computer or any other computing device as the user computer 104a, 104b. For purposes of this disclosure, discussion of communication with a user or entity or activity performed by the user or entity may be interpreted as communication with a computer 104a, 104b associated with the user or entity or activity taking place on a computer associated with the user or entity. A POS 106a-106b may be located within a store and may be part of a POS network. In some embodiments, a POS 106a, 106b may be operable to process online transactions. In some embodiments, separate computers of the server system 102a, 102b may handle communication with the user computers 104a, 104b and POS 106a, 106b.

Some or all of the server systems 102a, 102b, user devices 104a, 104b, and POS 106 may communicate with one another by means of a network 108. The network 108 may be embodied as a peer-to-peer wireless connection between devices, a connection through a local area network (LAN), WiFi network, the Internet, or any other communication medium or system.

The server system 102a may be associated with a merchant, or other entity, providing one or both of electronic receipt archiving and purchase activity-monitoring services. The server system 102b may be associated with an online task delegation service that may be owned or controlled by the same or a different entity than the merchant server system 102a. For example, the server system 102b may implement a system such as that provided by TaskRabbit™. In some embodiments, task delegation services are provided by the merchant server system 102a. In other embodiments, all of the methods described herein are provided by a server system 102b that is independent of any particular merchant.

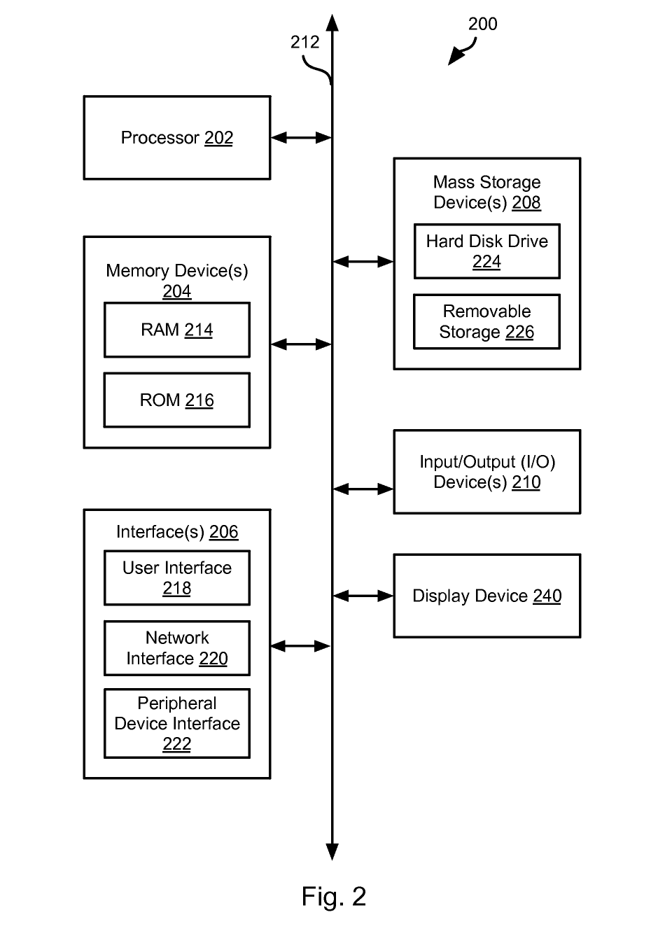

FIG. 2 is a block diagram illustrating an example computing device 200. Computing device 200 may be used to perform various procedures, such as those discussed herein. A server system 102a, 102b, user computer 104a, 104b, and POS 106a, 106b may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

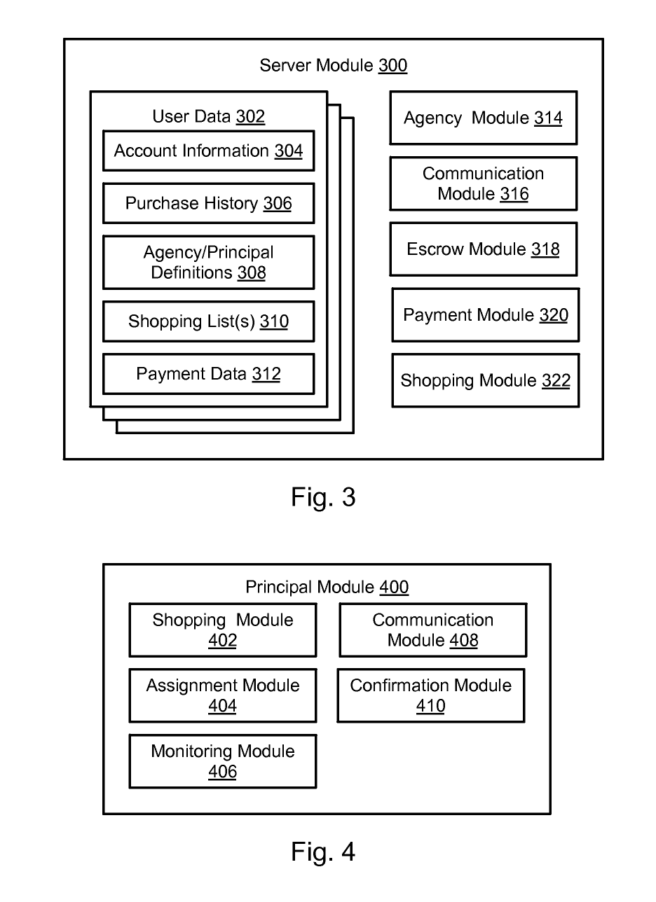

FIG. 3 illustrates a server module 300 that may implement methods described herein. The server module 300 may be hosted by a server system 102a, 102b or otherwise interface with a server system 102a, 102b. Some or all of the functionality of the server module 300 may also be implemented by a user computing device 104a, 104b.

The server module 300 may include user data 302 or the ability to access user data 302 from a database. The user data 302 may include account information 304 for a user, such as a user name, password, actual name, demographic data, or any other information to uniquely associate an account with a user and define the account. The user data 302 may provide a repository of transaction data for the user, which may be in the form of electronic receipts for transactions conducted by the user at an in-store point of sale (POS). Accordingly, the user data 302 may include purchase history 306 that includes some or all of a user's transaction data. As will be described in greater detail below, the purchase history 306 may be updated with transaction information as transactions occur. As also described in greater detail below, both transactions of the user conducted at a POS as well as transactions conducted by an agent of the user may be reported and stored in purchase history 306.

The user data 302 may include data facilitating a user's role as a principal or agent in the delegation of shopping tasks according to methods described herein. For purposes of this disclosure, embodiments may have exclusively principal users and agent users such that only data and functionality associated with a principal or agent, respectively, are associated with each type of account. In other embodiments, any user may occupy the role of either principal or user.

The user data 302 may include one or more agency or principal definitions 308. An agency definition may include a list of one or more user identifiers of users that are principals for the user. Likewise, a principal definition may include a list of users for which the user is a principal. Other data may be associated with a principal or agency definition, such as start time, a shopping list or link to a shopping list, expiration time, privileges, and the like. In particular, an agency or principal definition may limit the privileges of an agent with respect to the principal's account. For example, an agent may be limited to associate transactions with the principal's account or view a shopping list associated with the agency relationship, but otherwise be unable to access or change the user data 302 of the principal. In some embodiments, a user may grant more or fewer privileges to an agent with respect to the user's account.

The user data 302 may include one or more shopping lists 310 that include one or both of items compiled by the user and items suggested based on the user's purchase history 306. In some embodiments, payments to one or both of an agent and an online task delegation service may be automatically made in the methods described herein. Accordingly, the user data 302 may include payment data 312 such as credit card numbers, other electronic accounts, credits associated with the user due to gift cards, returns, or prepayments, and any other type of financial information.

The server module 300 may include an agency module 314 the agency module 314 may solicit agents for performing tasks, respond to requests for agents from principals, and perform other tasks involved in establishing an agency relationship. In some embodiments, an online task delegation service is used to request agents, select agents, and settle payment for agency relationships. Accordingly, the agency module 314 may interface with the online task delegation service. For example, the agency module 314 may automatically post requests for agents to the service for a shopping list upon the request of the principal. The agency module 314 may likewise automatically select an agent from those returned by the service and authorize payment to the selected agent once one or both of the purchase history 306 and the principal indicate that a shopping list has been purchased and delivered.

A communication module 316 may facilitate communication between principal and agent. For example, a principal may modify a shopping list sometime between when the agency relationship is created to purchase the shopping list and the purchase is actually made. Accordingly, a communication module 316 may communicate such updates to the agent as they occur. In some embodiments, these updates are transmitted for display to the agent as they occur in effectively real time. In some embodiments, voice or text messages may also be received from the principal and sent to the agent by the communication module 316.

In some embodiments, the interests of agent and principal may be protected using the concept of an escrow account. Accordingly, an escrow module 318 may charge an electronic account of the principal and hold the funds until the agency relationship is settled. For example, the escrow module 318 may charge an electronic account of a principal once purchase of the shopping list is detected. The amount charged may include one or both of the cost of purchasing the shopping list and compensation to the agent. The funds may be released to the agent upon the occurrence of either of purchasing of the shopping list, as detected from the purchase history 306, for example, or upon receiving confirmation from the principal of delivery of the items of the shopping list. Releasing the funds to the agent may include transferring the funds or authorizing transfer of the funds to the task delegation service through which the agency relationship was arranged.

A payment module 320 of the server module 300 may process the details of electronic transfer of funds from principal to agent, either with or without the use of an escrow account. The payment module 320 may implement some or all of the functionality to provide a secure transfer of funds from principal to agent. The payment module 320 may interface with a financial institution or payment processing company in order to accomplish the transfer of funds.

In some embodiments, particularly those where the server module 300 is hosted by a merchant, the server module 300 may include a shopping module 322. The shopping module 322 may interface with, or provide, a browser for navigating a product catalog by the principal on the user device 104a, 104b of a principal and for receiving selections of products for addition to the shopping list transmitted from the principal.

FIG. 4 illustrates a principal module 400. The principal module may be hosted by a user device 104a, 140b of a principal or a user device 104a, 104b may interface with the principal module 400 hosted by another device, such as a merchant server system 102a, or server system 102b of a task delegation service.

The principal module 400 may include a shopping module 402. The shopping module 402 of the principal module 400 may interface with an electronic product catalog to enable a user to browse products and add products to a shopping list. An assignment module 404 may receive instructions from a principal to post a task to purchase items on a shopping list. The assignment module 404 may issue the instruction directly to an online task delegation service or refer the instruction to the server module 300 for processing as described above. In some embodiments, where multiple responses are received, these responses may be provided to the principal module 400 and presented to the principal. The responses may include sufficient information to enable the principal to select a response such as a fee to the agent, proximity, experience, and the like. In some embodiments, a fee for a shopping task may be fixed automatically as a function of one or more of the number of items, a number of bids received for the task, the total purchase price, a weight of the combined purchases, a volume of the combined purchases, and other attributes of the shopping list or items of the shopping list. Accordingly, the assignment module 404 may visually present this information in a navigable fashion to the principal. The assignment module 404 may likewise receive the principal's selection of a respondent. In some embodiments, an agent is automatically selected based on the respondent's attributes by the assignment module or automatically select a first received. For example, a respondent that is less than 21 may be excluded from selection to fulfill a shopping list that includes alcohol. Filtering out of unqualified agent may also occur at the distribution stage, i.e., tasks to fulfill a shopping list may only be distributed to potential agents that are appropriate to fulfill the shopping list. In either case, where selection is performed by the principal module 400, this selection may be sent to the merchant server system 102a, the online task delegation service server system 102b, a module executing on the principal's user device, or some other entity that will implement the methods described herein.

The principal module 400 may include a monitoring module 406. In some situations, a principal may wish to monitor the agent's pick up of items on the shopping list. Accordingly, the agent may check off items from the list as they are retrieved. Notifications of check off of items may be transmitted for display by the monitoring module 406 to the principal, such as by means of the server system 102a, and may be presented to the principal on the principal's user device. In some embodiments, display of notifications may be augmented by advertising relevant to the items of the shipping list.

The principal module 400 may include a communication module 408. As noted above, communication between the principal and agent may be permitted during the course of the agency relationship. Communication may be direct between the user devices of principal and agent, such as by means of email and text message. In some embodiments, communication between principal and agent may be performed by means of modules in accordance with embodiments disclosed herein and may be performed by means of a server module 300. In such embodiments, the communication module 408 may receive inputs from the principal and forward these inputs to the agent and receive inputs from the agent and present these inputs to the principal.

As noted above, payment to the agent may be authorized upon confirmation or authorization by the principal. Accordingly, a confirmation module 410 may prompt the principal to provide confirmation after detecting that the items of a shopping list have been one or both of checked off the list and paid for. Detecting purchase of the items may include receiving notification from the server system 102 once the purchase history data of the user indicates purchase of the items. An input from the principal may be received by the confirmation module 410 indicating that the principal has acknowledged delivery of the items of the assigned shopping list. If so, then the confirmation module 410 may send notification to an entity to authorize payment to the agent. This may include sending notification to one of the server module 300, the online task delegation module, or some other entity to trigger authorization of payment or payment to the agent.

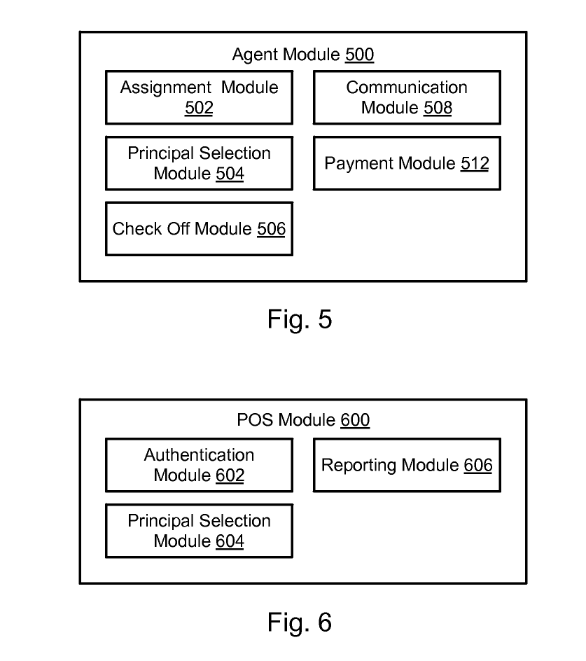

FIG. 5 illustrates an agent module 500. The agent module 500 may be hosted by a user device 104a, 140b of an agent or a user device 104a, 104b may interface with the agent module 500 hosted by another device, such as a merchant server system 102a, or server system 102b of a task delegation service.

The agent module 500 may include an assignment module 502. The assignment module 502 may receive assignments of tasks from principals upon acceptance of the agent. The assignment module 502 may also receive potential assignments from one of the user devices of potential principals, the server module 300, and an online task delegation service. The assignment module 502 may provide an interface enabling navigation of potential assignments by an agent. The interface may additionally receive parameters and filter potential assignments according to the received parameters. For example, an agent may filter assignments by one or more of a location of a store, a location of a principal, a required time of delivery, a number of items, a total number of items, a number of bids received for the task, a bid closing time, or the like. The assignment module 502 may receive agent selection of principals as well as parameters defining the agent's proposal to the principal's shopping task and transmit the proposals to the server system 102a or to a server system 102b of a online task delegation service. Upon selection of an agent's proposal by a principal, notification of the selection may be received by the assignment module 502 and added to a queue of tasks for the agent.

Inasmuch as shopping tasks may be small and infrequent, an agent may perform tasks for multiple principals. Accordingly, the agent module 500 may include a principal selection module 504. The principal selection module 504 may present to the agent a list of principals for which the agent has been selected to perform tasks that are not yet concluded, a list of tasks including one or both of uncompleted tasks and tasks for which payment has not been received. The principal selection module 604 may provide any interface known in the art for managing and navigating a list of principals and the status of tasks that have been assigned by the principals. The principal selection module 504 may also visually present those tasks for which the agent has submitted proposals but the corresponding principal has not yet selected an agent or otherwise removed the task.

The agent module 500 may include a check off module 506. As already noted, the shopping tasks delegated to an agent in accordance with the methods described herein may be a shopping list. The check off module 506 may receive the agent's inputs indicating the pick up of items on a shopping list. A check off of an item may be received by first selecting an assigned task and the corresponding shopping list using the principal selection module 504. Thereafter, inputs may be received by the agent module 500 from the agent, such as by selecting an item on a visually represented list, detecting scanning of an optical code associated with a product (e.g. a universal product code (UPC)), or detecting the product label in an image taken using the camera of an agent's mobile phone. As already discussed, the check off module 506 may transmit notice of check offs of items to the corresponding principal.

In some embodiments an agent may shop for multiple principals at once. In such embodiments, a check off module 506, or some other module, may present a combined list including all items of all shopping lists to be picked up for the multiple principals. An agent may therefore avoid the annoyance of having to constantly navigate between multiple lists.

The agent module 500 may include a communication module 508. As already discussed, communication between principal and agent may be facilitated during the course of the agency relationship. Accordingly, the communication module 508 may receive inputs from the agent and transmit them to a selected principal and receive messages from a principal and present them to the agent.

The agent module 500 may include a payment module 512. The payment module 512 may facilitate the transfer of payments to the agent. For example, the payment module may maintain or provide access to an electronic account for receiving payments on behalf of the agent.

FIG. 6 illustrates a POS module 600. The POS module 600 may be implemented on a POS 106a, 106b or may provide an interface to a POS 106a, 106b for performing the functions ascribed to a POS 106a, 106b in the methods described herein. The POS module 600 may include an authentication module 602. The authentication module 602 may provide a secure means to authenticate a user conducting a transaction at a POS 106a, 106b. In other embodiments, only means for identifying the user may be used without need for actual security. The authentication module 602 may receive a username or user name and password at the POS from a customer at the POS 106a, 106b in order to authenticate a user. The authentication module 602 may also detect scanning of an optical code or reading of a magnetic strip on a card in the possession of the customer and use the data read to authenticate the customer or otherwise associate the code with a transaction for future association with a customer's account.

Where the customer authenticated is an agent performing a shopping task for one of multiple possible principals, a principal selection module 604 may retrieve these principals, such as from the server system 102a or the user device of an agent or principal, present the principals on the POS 106a, 106b, and receive a selection of a principal with whom to associate the current transaction. Details of the transaction may be transmitted by a reporting module 606 to one or more of the server system 102a and a principal module 400 to enable confirmation of completion of a task by the principal as described herein. In instances where the customer is an agent, the transaction data will be associated with the selected principal. Where the customer is conducting a transaction on the customer's behalf, the transaction data will be associated with the account of that customer in accordance with the authentication by the authentication module 602.

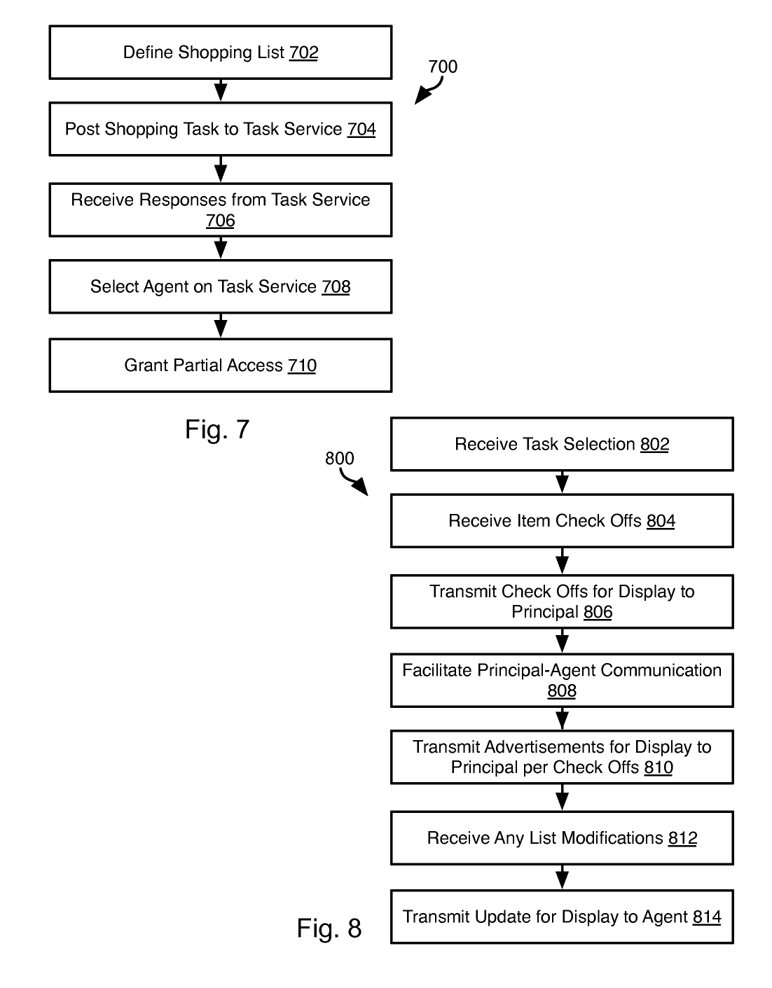

FIG. 7 illustrates a method 700 for setting up a delegation of a shopping task. The method 700 may include defining 702 a shopping list. The step of defining 702 a shopping list may be performed on a principal's user computing device 104a, 104b or may be performed on the server system 102a through an interface presented on the principal's user computing device 104a, 140b. The step of defining 702 a shopping list may include one or more of receiving typed in product names, receiving selections of items from a list of products from a product catalog, receiving data from scanning of an optical code (e.g. barcode) of a product using a camera of the principal's user computing device 104a, 104b, or some other means.

The shopping list may then be posted 704 to potential agents. As already noted one or more of the steps of posting a task, collecting responses, receiving a selection of a response, and settling the delegation of a task on completion may be performed by a task delegation service. Alternatively, one or more of these steps may be performed by a merchant's server system 102a. Posting 704 a task may include posting the shopping list along with one or more other parameters, such as a date by which purchase should be accomplished, any comments by the principal, or other instructions. For example, a principal may designate that cheaper alternatives to listed product may be purchased.

Responses to the task may be received 706, such as from the task service or from respondents by one of the modules disclosed herein. In some embodiments, the step of selecting an agent from the received responses may be performed automatically by the principal module 400 or the server module 300. Accordingly, whichever module or device that performs the selection may receive 706 the responses. Where the principal actually makes the selection, the responses may be transmitted for display on the principal's user device 104a, 104b.

An agent from among the received 706 responses may be selected 708, either automatically by the above described entities or modules or by the principal through an interface on the principal's user device 104a, 140b. Selection 708 may include transmitting to the selected agent or a user account of the selected agent a notice of the selection, which may include some identifier of one or both of the task and principal for which the agent was selected.

Partial access to the selected agent to an account of the principal that posted the task for which the agent was selected may be granted 710. Granting 710 of partial access may occur on the server system 102a or whichever entity provides access to user data 302.

Partial access may be partial in one or more senses. For example, access may be temporary, read only, only apply to specific data, or the like. For example, partial access may include access lasting until the task is confirmed by the principal to be complete, that only allows read access to an assigned shopping list, and only allows the selected agent to associate transaction data with the account of the principal for purchases at a POS 106a, 106b. In some embodiments partial access may also only allow transactions to be associated with the principal's account for items in the assigned shopping list.

FIG. 8 illustrates a method 800 that may be executed on behalf of an agent, such as by an agent module 500. The method 500 may be executed on an agent user computing device 104a, 104b or on a server system 102a with an interface provided on the agent user computing device 104a, 104b.

The method 800 may include receiving 802, from the agent, a task selection. As already noted, an agent may perform multiple tasks for multiple principals. Accordingly, a list of these tasks in a navigable form may be displayed to the agent and an input selecting one of these tasks may be received 802. Check offs of items on the shopping list for the selected task may then be received as input to the agent's user computing device 104a, 104b. These check offs of items may be transmitted 806 for display to the principal. The check offs may also be transmitted 806 to the server system for use in accordance with methods described herein.

Communication between the agent and principal may be facilitated 808. Facilitating 808 communication may include transmitting contact information for communication outside of the components described herein may be provided to agent and principal, such as phone numbers or email addresses. Facilitating 808 communication may include receiving by a server system 102a messages from one user computing device 104a, 140b and forwarding the message to an appropriate user computing device 104a, 104b for viewing by an addressed agent or principal.

In some embodiments, targeted advertisements may be transmitted 810 for display to a principal, such as on a principal's user computing device, according to one or more of the principal's purchase history, the principal's user profile (e.g. demographic, tastes, preferences, etc.), the items listed on the shopping list, and a recently checked off item. For example, the advertisements may list items that are less expensive, of higher quality than those listed on the shopping list, or complementary to one or more items listed on the shopping list. In some embodiments, an interface element on the advertisement may, upon selection by the principal, invoke substitution of an advertised item for an item on the shopping list assigned to be picked up by an agent or an addition of an item to the list. Accordingly, any list modifications added due to interaction by the principal with an advertisement or otherwise made by the principal may be received 812 and transmitted 814 to the agent for display to the agent and for receiving check off of the added or modified items.

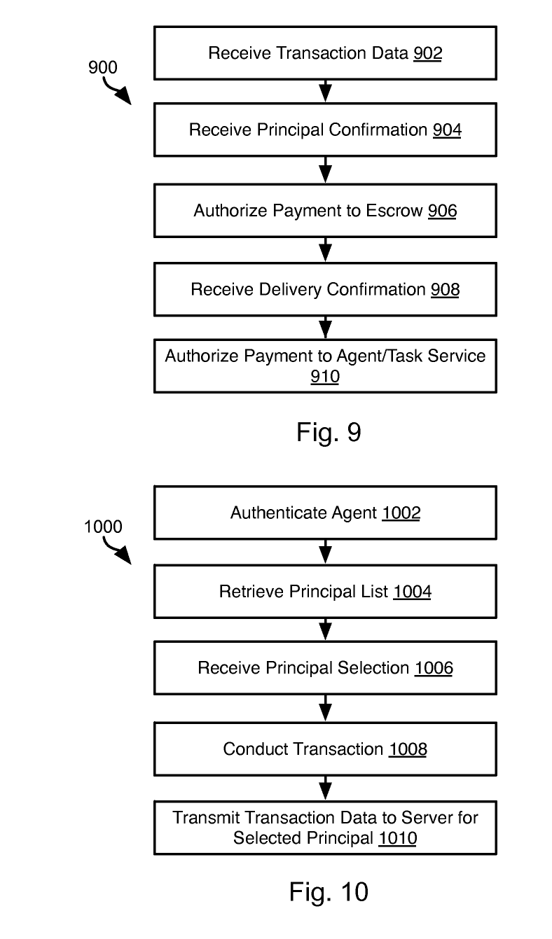

FIG. 9 illustrates a method 900 for settling a delegated shopping task. As for other methods described herein, some or all of the steps of the method 900 may be executed by one or more of the server system 102a and a user computing device 104a, 104b.

The method 900 may include receiving 902 transaction data from a POS 106a, 106b. The transaction data may identify the principal for which the transaction was performed as well as other transaction data such as items purchased, amount paid, the manner of payment, an identifier of the agent that made the purchase, an identifier of the shopping list being purchased, or the like. Upon receiving the transaction data for a shopping list the server module 300 or principal module may receive the transaction data and evaluate the transaction data with respect to the shopping list corresponding to the transaction. If the data matches, i.e. each item has been purchased, then a prompt may be issued to the principal, such as on the principal's user device 104a, 104b to confirm that the purchase is correct and the principal's confirmation or refusal to confirm may be received. In other embodiments, the purchase may be confirmed automatically if the shopping list and transaction items match and the principal may be prompted to confirm only if there is a difference (e.g. a substitution or omission due to an item being out of stock).

Upon confirmation of the purchase, payment may be authorized 906 to an escrow account. Authorizing payment may include authorizing charging of an electronic account of the principal using financial information provided by the principal. The amount authorized may include one or both of the price of the transaction and a fee for the agent. A principal may be provided an interface element to confirm delivery of the items of the shopping list. Accordingly, the method 900 may include receiving 908, such as from the principal's user device 104a, 104b, confirmation of delivery. Upon receiving this confirmation, release of the funds from escrow and payment thereof to the agent may then be authorized 910. Where an online task delegation service is used, payment may be authorized 910 to the service for the task performed by the agent.

In some embodiments the use of an escrow account may be omitted. In such embodiments, authorizing 910 payment to the agent may authorize payment from the principal directly to the agent or online task delegation service, rather than release of funds from an escrow account

FIG. 10 illustrates a method 1000 that may be performed by a POS 106a, 106b that is participating in methods such as those described hereinabove. Some or all of the steps of the method 1000 may be performed by a server system 102a or user device 104a, 104b with an interface provided on the POS 106a, 106b.

The method 1000 may include authenticating 1002 the agent. This may include one or more steps of receiving a user identifier (typed in or scanned), transmitting the user identifier to a server system 102a, and receiving from the server system 102a confirmation that the user identifier (and possibly a password) are correct.

The method 1000 may include one or both of requesting and retrieving 1004 a list of principal's with which the agent has an agency relationship to perform shopping tasks. The list may be displayed or otherwise presented on the POS 106a, 106b and a selection of a principal may be received 1006 as input by a cashier or the agent. In some embodiments, a selection of a principal may be transmitted to the POS 106a, 106b from the agent's user device 104a, 104b, such as by way of the server system 102a. In some embodiments, an agent may select multiple principals.

The transaction may then be conducted 1008 in the traditional matter with items being added to an order and payment being received from the agent. The transaction data may then be transmitted 1010 to a server for archiving and for processing according to the other methods described herein, such as for verifying completion of the task in order to transfer funds to escrow or authorize release of funds to the agent or online task delegation service. The transaction data may include one or more of an identifier of the agent, an identifier of the principal, in addition to a description of the transaction such as the items purchased, amount paid, payment method used, and the like. In instances where a transaction is on behalf of multiple principals, the transaction data may be compared to shopping lists of the multiple principal's that the agent is fulfilling and items may be assigned to corresponding principals. This may occur at the POS 106a, 106b, server system 102a, or a user computing device 104a, 104b of an agent or principal. The items of the transaction may then be assigned or associated with the purchase history of a corresponding principal for whom the item was in the shopping list assigned by that principal to the agent. Where the same item is on multiple lists, an appropriate quantity of the item may be assigned to each principal in accordance with a quantity listed on that principal's shopping list.

The systems and methods described herein may advantageously be used in other contexts in order to achieve the benefits of the embodiments described herein. For example, the partial access granted to an agent in accordance and the methods described herein may be used to enable an agent to return items for a principal in the place of the shopping tasks in the methods described above. In such instances, upon acceptance of an agent's proposal, or at some point prior to transferring the items to be returned to the agent, a deposit may be charged to an electronic account of the selected agent for a value of the item or items to be returned and the deposit may be refunded to the agent as soon as the refund for the returned items has been credited to the principal or the principal confirms that the refund money has been received from the agent in accordance with the confirmation steps described herienabove. At the POS, the agent may be authenticated and a principal selected for the return as in the other methods described hereinabove. However, rather than associating purchases with the principal's account, the returned items may be associated with the principal's account and the transaction in which the returned items belong. The delegation of the return task in accordance to the methods described herein may additionally identify the transaction, such as a unique transaction identifier, that may be used by the agent or otherwise provided to the POS to identify the transaction at the POS.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for delegating shopping tasks, the method comprising:
posting, by a computer system, a task including a shopping list of a principal;
receiving, by the computer system, one or more responses to the task;
providing, by the computer system, partial access to a shopping account of the principal to an agent corresponding to a selected response of the one or more responses;
associating, by the computer system, purchases of the agent with the shopping account of the principal; and
revoking partial access to the shopping account of the principal to the agent.

2. The method of claim 1, further comprising:
transmitting, by the computer system, for display to the principal notification of purchases of the agent;
receiving, by the computer system, confirmation, from a user device of a principal, of delivery of the purchases of the agent; and
authorizing, by the computer system, payment to the agent upon receiving the confirmation of delivery.

3. The method of claim 1, wherein posting the task including the shopping list of a principal further comprises posting the task including the shopping list to an online task delegation service.

4. The method of claim 1, wherein associating, by the computer system, purchases of the agent with the shopping account of the principal further comprises:
receiving, by the computer system, transaction data describing the purchases of the agent and an identifier of the principal from a point of sale (POS).

5. The method of claim 1, wherein associating, by the computer system, purchases of the agent with the shopping account of the principal further comprises:
receiving, by the computer system, an agent identifier from a point of sale (POS);
transmitting, by the computer system, a principals list associated with the agent to the POS; and
receiving, by the computer system, transaction data describing the purchases of the agent and an identifier of a selected principal from the principals list from the point of sale (POS).

6. The method of claim 1, further comprising:
receiving, by the computer system, notifications of check off of items from the shopping list;
transmitting, by the computer system, the notifications of check offs for display to the principal in real time.

7. The method of claim 6, further comprising facilitating, by the computer system, communication between the principal and agent.

8. The method of claim 7, further comprising:
receiving, by the computer system, updates to the shopping list from a user device of the principal; and
transmitting, by the computer system, the updates for display to the agent.

9. The method of claim 1, wherein the partial access to the shopping account of the principal includes temporary read access to the shopping list and temporary permission to associate purchases with the shopping account of the principal.

10. The method of claim 1, further comprising:
defining, by the computer system, the shopping list of the principal in accordance to selections received from a product catalog from a user device of the principal.

11. A system for delegating shopping tasks, the system comprising one or more processors and one or more memory devices operably coupled to the one or more processors, the one or more memory devices storing executable and operational data effective to cause the one or more processors to:
post a task including a shopping list of a principal;
receive one or more responses to the task;
provide partial access to a shopping account of the principal to an agent corresponding to a selected response of the one or more responses;
associate purchases of the agent with the shopping account of the principal; and
revoke partial access to the shopping account of the principal to the agent.

12. The system of claim 11, wherein the executable and operational data are further effective to cause the one or more processors to:
transmit for display to the principal notification of purchases of the agent;
receive confirmation, from a user device of a principal, of delivery of the purchases of the agent; and
authorize payment to the agent upon receiving the confirmation of delivery.

13. The system of claim 11, wherein the executable and operational data are further effective to cause the one or more processors to post the task including the shopping list of a principal by posting the task including the shopping list to an online task delegation service.

14. The system of claim 11, wherein the executable and operational data are further effective to cause the one or more processors to associate purchases of the agent with the shopping account of the principal by receiving transaction data describing the purchases of the agent and an identifier of the principal from a point of sale (POS).

15. The system of claim 11, wherein the executable and operational data are further effective to cause the one or more processors to associate purchases of the agent with the shopping account of the principal by:
receiving an agent identifier from a point of sale (POS);
transmitting a principals list associated with the agent to the POS; and
receiving transaction data describing the purchases of the agent and an identifier of a selected principal from the principals list from the point of sale (POS).

16. The system of claim 11, wherein the executable and operational data are further effective to cause the one or more processors to:
receive notifications of check off of items from the shopping list;
transmit the notifications of check offs for display to the principal in real time.

17. The system of claim 16, wherein the executable and operational data are further effective to cause the one or more processors to facilitate communication between the principal and agent.

18. The system of claim 17, wherein the executable and operational data are further effective to cause the one or more processors to:
receive updates to the shopping list from a user device of the principal; and
transmit the updates for display to the agent.

19. The system of claim 11, wherein the partial access to the shopping account of the principal includes temporary read access to the shopping list and temporary permission to associate purchases with the shopping account of the principal.

20. The system of claim 11, wherein the executable and operational data are further effective to cause the one or more processors to define the shopping list of the principal in accordance to selections received from a product catalog from a user device of the principal.
